(19) United States
(12) Patent Application Publication
(10) Pub. No.: US 2013/0282852 A1
(43) Pub. Date: Oct. 24, 2013

(54) MULTI-FUNCTIONAL PORTABLE INFORMATION SHARING MANAGEMENT DEVICE

(71) Applicant: Yung-Chiang Chu, Taipei (TW)

(72) Inventor: Yung-Chiang Chu, Taipei (TW)

(73) Assignee: FLUIDITECH IP LIMITED, Victoria (SC)

(21) Appl. No.: 13/450,919

(22) Filed: Apr. 19, 2012

(51) Int. Cl. G06F 15/167

(52) U.S. Cl. 709/213

(57) ABSTRACT

A multifunctional portable data sharing management device for sharing data between electronic devices is introduced. The device establishes an online connection (including a direct connection or a connection via the Internet) with the electronic devices, and stores data provided by any one of the electronic devices into a local storage unit, and a processing unit transmits and broadcasts the data to the electronic devices, such that the electronic devices can share the data similar to a localized cloud sharing mode. The processing unit further performs a data conversion of the data according to a data code to achieve the effect of using the converted data freely in the electronic devices without the data code. In addition, the multifunctional portable data sharing management device can be connected to a cloud server on the Internet to share the data.

### FIELD OF THE INVENTION

The present invention relates to a multifunctional portable data sharing management device, in particular to the multifunctional portable data sharing management device provided for sharing data between electronic devices.

### BACKGROUND OF THE INVENTION

Present cloud computing technology relates to a computing method based on the Internet, and the cloud computing method can be used to share software and hardware resources for electronic devices according to requirements.

In the conventional cloud computing technology, a cloud storage space is arranged in a location by a system manufacturer or a device manufacturer and provided for users to access and share the software and hardware resources in the cloud storage space through the Internet. In addition, the storage space provided by the cloud computing technology is limited, so that the users need to passively take the arrangement made by the system manufacturer or the device manufacturer. In addition, if a plurality of electronic devices simply shares resources, then the electronic devices must be logged onto the Internet before the data on the Internet can be shared. This method is very inconvenient to the users.

Therefore, the present invention provides a multifunctional portable data sharing management device to overcome the deficiency of the prior art.

### SUMMARY OF THE INVENTION

It is a primary objective of the present invention to provide a multifunctional portable data sharing management device, such that data of any one of the electronic devices can be transmitted between the electronic devices to achieve effect of sharing data sharing between the electronic devices.

Another objective of the present invention is to provide a multifunctional portable data sharing management device, such that if original data of any one of the electronic devices cannot be access, a data conversion the original data can be performed to achieve the effects of sharing and managing the data of the electronic devices.

A further objective of the present invention is to provide a multifunctional portable data sharing management device to achieve the effects of sharing and managing the data between the electronic devices and a cloud server on the Internet.

To achieve the aforementioned and other objectives, the present invention provides a multifunctional portable data sharing management device provided for sharing and management data between a plurality of electronic devices, and the device comprises a communication unit, a local storage unit and a processing unit. The communication unit is coupled to at least one of the electronic devices directly through the Internet, and the electronic devices have the same communication protocol as that of the communication unit. The local storage unit is coupled to the communication unit and provided for storing the data of the electronic devices. The processing unit is coupled to the communication unit and the local storage unit and provided for accessing the data of the local storage unit, and the communication unit is provided for transmitting and broadcasting the data to the electronic devices, such that the electronic devices can share and use the data.

To achieve the aforementioned and other objectives, the present invention further provides another preferred embodiment of the multifunctional portable data sharing management device for sharing data between a cloud server and a plurality of electronic devices. The multifunctional portable data sharing management device comprises a communication unit, a local storage unit and a processing unit. The communication unit is coupled to the electronic devices and the cloud server through the Internet. The local storage unit is coupled to the communication unit and provided for selectively storing the data of the electronic devices. The processing unit is coupled to the communication unit and the local storage unit and provided for accessing the data stored in the cloud server and transmitting the data to the electronic devices through the Internet, such that the electronic devices can share and use the data.

Compared with the prior art, the multifunctional portable data sharing management device of the present invention is provided for a local storage unit to store shared data in any one of the electronic devices, so that the electronic devices can share the data easily through the multifunctional portable data sharing management device of the present invention. In addition, the electronic devices also can manage the data (such as modifying or changing the data), so that the most updated data can be transmitted and broadcasted to the electronic devices.

In a preferred embodiment, if any electronic device modifies the data of the corresponding local storage unit, the original data stored in the electronic device will not be affected, or the updated data can be used to replace the data in the electronic device.

In addition, if the data code of the data stored in the local storage unit does not match with the code supported by the electronic devices, then the present invention will perform a data conversion of the data, so that all converted data can be applied in all of the electronic devices. In another preferred embodiment, the present invention provides a way of sharing the data code that can be applied in the electronic devices to achieve the effect of sharing and managing the data between the electronic devices.

The multifunctional portable data sharing management device of the present invention further shares and manages data of the electronic devices through a cloud server to achieve the same functions and effects as described above.

In addition, the present invention provides different modes for the electronic devices to share and manage the data, and these modes mainly include a point-to-point mode and an access point mode, wherein the point-to-point mode is provided for the electronic devices to read the data directly from the local storage unit, and the access point mode is provided for the electronic devices to connect to the Internet through a communication unit. In the access point mode, the electronic devices can read the data from the cloud server on the Internet through the Internet.

### BRIEF DESCRIPTION OF THE DRAWINGS

FIG. 1 is a schematic block diagram of a multifunctional portable data sharing management device in accordance with a first preferred embodiment of the present invention;

FIG. 2 is a schematic block diagram of a multifunctional portable data sharing management device in accordance with a second preferred embodiment of the present invention; and

FIG. 3 is a schematic block diagram of a multifunctional portable data sharing management device in accordance with a third preferred embodiment of the present invention.

### DETAILED DESCRIPTION OF THE PREFERRED EMBODIMENTS

The objects, characteristics and effects of the present invention will become apparent with the detailed description of the preferred embodiments and the illustration of related drawings as follows.

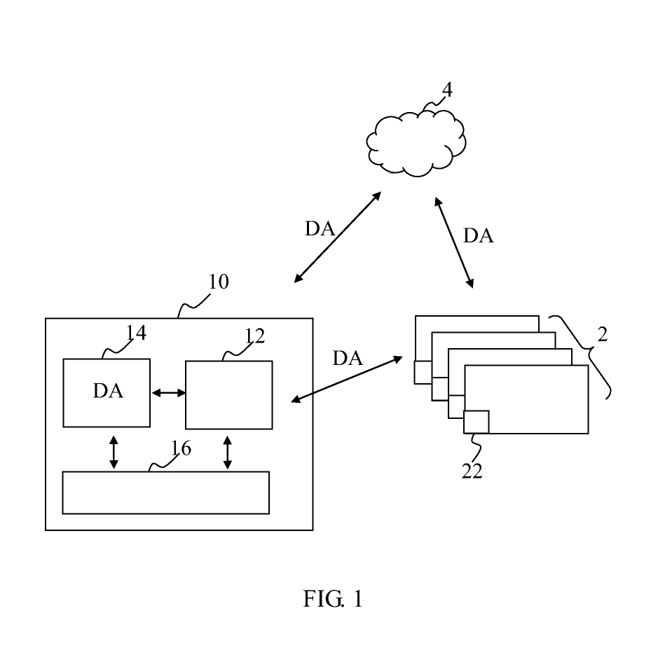

With reference to FIG. 1 for a schematic block diagram of a multifunctional portable data sharing management device in accordance with the first preferred embodiment of the present invention, the multifunctional portable data sharing management device 10 is provided for a plurality of electronic devices 2 to share and manage data DA among them. Wherein, the electronic devices 2 are Smartphones, flat PCs, desktop computers, and notebook computers. The data DA can be stored as a data file, an audio file or an audio file, particularly the data DA can be shared by the electronic devices 2. In addition, the electronic devices can be used together with an operating system such as Symbian, Windows Mobile, MS Win 7, Win 8, iOS, Linux (including Android, Maemo and WebOS), Palm OS and BlackBerry OS. In addition, the electronic devices 2 have a wireless communication unit 22 for transmitting and receiving the data DA.

The multifunctional portable data sharing management device 10 comprises a communication unit 12, a local storage unit 14 and a processing unit 16. Wherein, the communication unit 12 can be coupled to the electronic devices 2 by the following two methods: (1) The communication unit 12 is coupled to the electronic devices 2 directly; and (2) The communication unit 12 and the electronic devices 2 are coupled through the Internet 4. In addition, the wireless communication unit 22 of the electronic devices 2 has the same protocol as that of the communication unit 12. The communication protocol can be a Wireless Fidelity (Wi-Fi) communication protocol, a Bluetooth communication protocol, and a 3rd-generation (3G) communication protocol including CDMA2000, WCDMA, TD-SCDMA and WiMAX.

In addition, the communication unit 12 has a point-to-point mode and an access point mode. Wherein, the point-to-point mode is provided for the electronic devices 2 to read the data DA in the local storage unit 14 directly, and the access point mode is provided for the electronic devices 2 to connect the Internet 4 through the communication unit 12. It is noteworthy to point out that if the communication unit 12 is in the access point mode, then the communication unit 12 adopts the Wi-Fi communication protocol and the 3G wireless communication protocol, so that the electronic devices 2 can connect to the Wi-Fi communication protocol in the communication unit 12 through the Wi-Fi communication protocol, and then connected to the Internet 4 through the 3G wireless communication protocol. In other words, the communication unit 12 can be used for a local connection for the electronic devices 2, and also can be used for sharing the Internet 4 through the electronic devices 2. In addition, the communication unit 12 can be switched to determine the way of connecting the communication unit 12 with the electronic devices 2.

For example, if the communication unit 12 adopts a wireless fidelity (Wi-Fi) communication protocol, the point-to-point mode of the communication unit 12 corresponds to the Wi-Fi direct mode, and the access point mode corresponds to the Wi-Fi mode.

The local storage unit 14 is coupled to the communication unit 12, and the local storage unit 14 is provided for storing the data DA of the electronic devices 2. For example, the local storage unit 14 can be a flash memory or a hard disk.

The processing unit 16 is coupled to the communication unit 12 and the local storage unit 14 and provided for accessing the data DA of the local storage unit 14, and the communication unit 12 transmits and broadcasts the data DA to the electronic devices 2, such that the electronic devices 2 can use the data DA. Wherein, the word “use” refers to simply sharing the data or synchronously modifying the data.

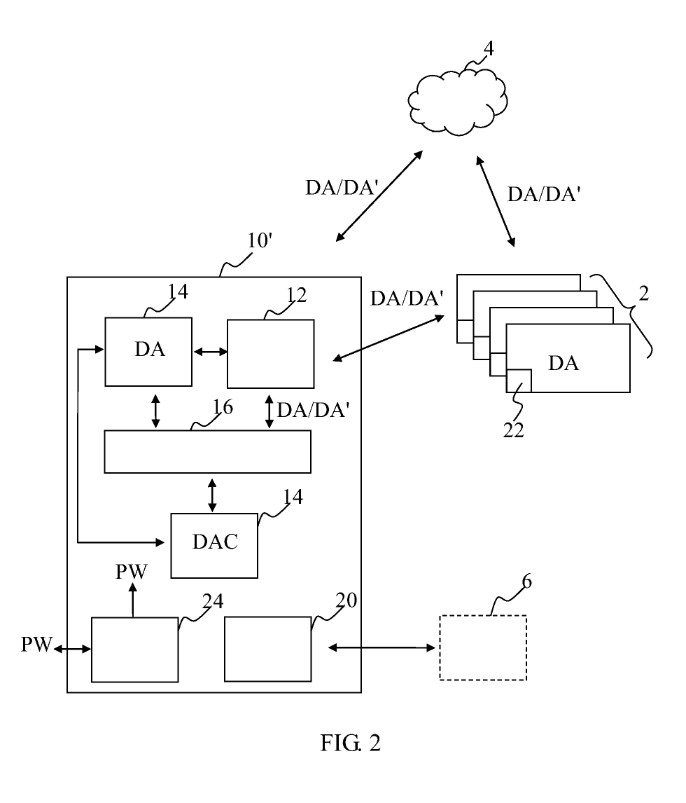

With reference to FIG. 2 for a block diagram of a multifunctional portable data sharing management device in accordance with the second preferred embodiment of the present invention, the multifunctional portable data sharing management device 10′ is similarly provided for the plurality of electronic devices 2 to share and manage data between them. The multifunctional portable data sharing management device 10′ similarly comprises the communication unit 12, the local storage unit 14 and the processing unit 16, and the difference resides on that the multifunctional portable data sharing management device 10′ further comprises a media code unit 18 having a data code DAC stored therein, and coupled to the processing unit 16 and/or the local storage unit 14. The media code unit 18 is provided for performing a coding or decoding data conversation of the data DA by the data code DAC to produce another data DA′. In other words, the data DA received from the electronic devices 2 can be converted by the data code DAC through the processing unit 16 (or the media code unit 18) to form the data DA′. For example, the data code is in an audio video interleave (AVI) format, a windows media video (WMV) format, a movie picture experts group (MPEG) format, a Real format, a QuickTime format, a H.264 format and a MPEG-4 format.

In addition, the data DA can be converted by the following two methods: (1) The electronic devices 2 download the data code DAC from the media code unit 18 through the communication unit 12, and use the data code DAC to perform a data conversion of the data DA in the electronic devices 2; and (2) The processing unit 16 performs a data conversion of the data DA in the local storage unit 14 to form another data DA′ and transmits and broadcasts the data DA′ to the electronic devices 2, such that the electronic devices 2 can share the data DA′, wherein the electronic devices 2 are installed with different operating systems, and an additional external application program (APP) is required for reading the converted data DA′.

In addition, the processing unit 16 transmits and broadcasts the data DA′ in form of a data stream to the electronic devices 2.

In another preferred embodiment, the multifunctional portable data sharing management device 10′ further comprises a port unit 20 coupled to the processing unit 16, and provided for connecting an external multimedia storage unit 6 to transmit the multimedia data MDA stored in the multimedia storage unit 6 to the local storage unit 14 through the port unit 20. For example, the port unit 20 can be a card reader or a universal serial bus (USB).

In another preferred embodiment, the multifunctional portable data sharing management device 10′ further comprises a power supply unit 24 coupled to the communication unit 12, the local storage unit 14 and the processing unit 16, and provided for supplying required power PW to the communication unit 12, the local storage unit 14 and the processing unit 16, and selectively outputting the power PW to the outside of the multifunctional portable data sharing management device 10′ for the use by the electronic devices 2. Wherein, the power supply units 24 supplies or stores the power PW through an externally connected utility power or battery (including primary or secondary batteries).

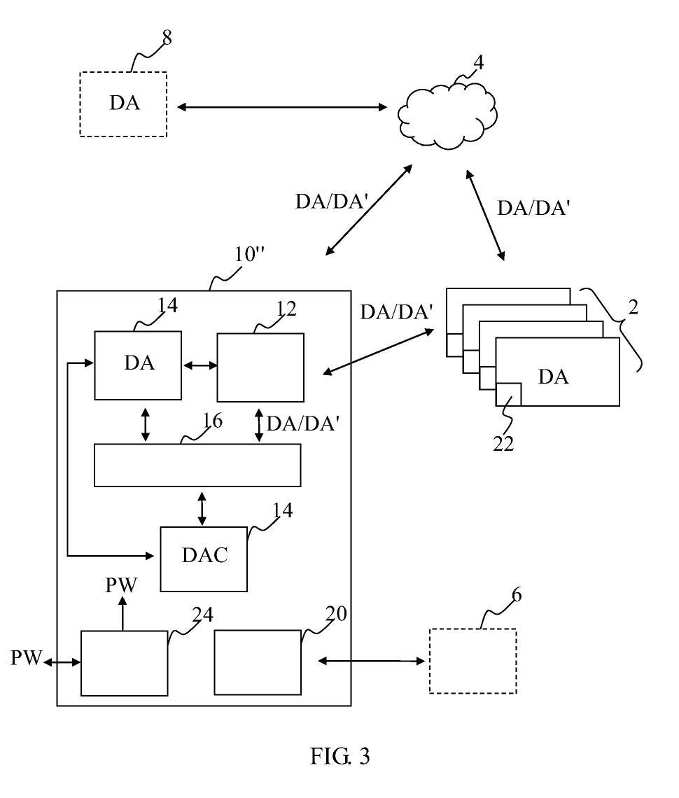

With reference to FIG. 3 for a block diagram of a multifunctional portable data sharing management device in accordance with the third preferred embodiment of the present invention, the multifunctional portable data sharing management device 10″ is provided for sharing the data DA between a cloud server 8 and a plurality of electronic devices 2. The multifunctional portable data sharing management device 10″ similarly comprises the communication unit 12, the local storage unit 14 and the processing unit 16. The communication unit 12 is coupled to the electronic devices 2 and the cloud server 8 through the Internet 4. In other words, the communication unit 12, the electronic devices 2 and the cloud server 8 are connected through the Internet 4.

The local storage unit 14 is coupled to the communication unit 12, and the storage unit 14 is provided for selectively storing the data DA of the electronic devices 2.

In another preferred embodiment, the data DA can be stored in the local storage unit 14 or in the cloud server 8. Wherein, the data DA stored in the cloud server 8 can be stored back to the local storage unit 14 to perform the aforementioned data conversion or transmit the converted data DA′ back to the electronic devices 2 or the cloud server 8.

The processing unit 16 is coupled to the communication unit 12 and the local storage unit 14, and the processing unit 16 is provided for accessing the data DA stored in the cloud server 8, and transmitting the data DA to the electronic devices 2 through the Internet 4 for the electronic devices 2 to share the data DA.

In another preferred embodiment, the multifunctional portable data sharing management device 10″ also comprises the media code unit 18, the port unit 20 and the power supply unit 24.

Therefore, the multifunctional portable data sharing management device of the present invention is provided for a local storage unit to store shared data in any one of the electronic devices, so that the electronic devices can share the data easily through the multifunctional portable data sharing management device of the present invention. In addition, the electronic devices also can manage the data (such as modifying or changing the data), so that the most updated data can be transmitted and broadcasted to the electronic devices.

If any electronic device modifies the data of the corresponding local storage unit, the original data stored in the electronic device will not be affected, or the updated data can be used to replace the data in the electronic device.

In addition, if the data code of the data stored in the local storage unit does not match with the code supported by the electronic devices, then the present invention will perform a data conversion of the data, so that all converted data can be applied in all of the electronic devices. In another preferred embodiment, the present invention provides a way of sharing the data code that can be applied in the electronic devices to achieve the effect of sharing and managing the data between the electronic devices.

The multifunctional portable data sharing management device of the present invention further shares and manages data of the electronic devices through a cloud server to achieve the same functions and effects as described above.

The present invention further provides different modes for the electronic devices to share and manage the data, and these modes mainly include a point-to-point mode and an access point mode, wherein the point-to-point mode is provided for the electronic devices to read the data directly from the local storage unit, and the access point mode is provided for the electronic devices to connect to the Internet through a communication unit. In the access point mode, the electronic devices can read the data from the cloud server on the Internet through the Internet.

While the invention has been described by means of specific embodiments, numerous modifications and variations could be made thereto by those skilled in the art without departing from the scope and spirit of the invention set forth in the claims.

What is claimed is:

1. A multifunctional portable data sharing management device, provided for sharing and managing data between a plurality of electronic devices, and the device comprising:
a communication unit, coupled to at least one of the electronic devices through the Internet directly, and the electronic device having the same communication protocol as the communication unit;
a local storage unit, coupled to the communication unit, and provided for storing the data of the electronic devices; and
a processing unit, coupled to the communication unit and the local storage unit, and provided for accessing data of the local storage unit, and transmitting and broadcasting the data to the electronic devices through the communication unit, such that the electronic devices jointly use the data.

2. The multifunctional portable data sharing management device of claim 1, wherein the communication unit has a point-to-point mode and an access point mode, and the point-to-point mode is provided for the electronic devices to read the data in the local storage unit directly, and the access point mode is provided for the electronic devices to connect to the Internet through the communication unit.

3. The multifunctional portable data sharing management device of claim 2, wherein the communication unit comes with a communication protocol including a wireless fidelity (Wi-Fi) communication protocol, a Bluetooth communication protocol and a third-generation (3G) wireless communication protocol.

4. The multifunctional portable data sharing management device of claim 3, wherein the point-to-point mode of the communication unit is a Wi-Fi direct mode and the access point mode is a Wi-Fi mode, if the communication unit comes with the Wi-Fi communication protocol.

5. The multifunctional portable data sharing management device of claim 1, further comprising a media code unit having a data code stored therein, and coupled to at least one of the processing unit and the local storage unit, and provided for performing a coding/decoding data conversion of the data by the data code.

6. The multifunctional portable data sharing management device of claim 5, wherein the data code has a video format selected from the collection of an Audio Video Interleave (AVI) format, a Windows Media Video (WMV) format, a Moving Picture Experts Group (MPEG) format, a Real format, a QuickTime format, a H.264 format and a MPEG-4 format.

7. The multifunctional portable data sharing management device of claim 5, wherein the electronic devices download the data code from the media code unit through the communication unit and use the data code to perform the data conversion of the data in the electronic devices.

8. The multifunctional portable data sharing management device of claim 5, wherein the processing unit performs a data conversion of the data situated in the local storage unit, and transmits and broadcasts the data to the electronic devices.

9. The multifunctional portable data sharing management device of claim 7, wherein the processing unit transmits and broadcasts the data to the electronic devices by a data stream method.

10. The multifunctional portable data sharing management device of claim 8, wherein the processing unit transmits and broadcasts the data to the electronic devices by a data stream method.

11. The multifunctional portable data sharing management device of claim 1, further comprising a port unit coupled to the processing unit and provided for connecting an external multimedia storage unit to transmit multimedia data stored in the multimedia storage unit to the local storage unit through the port unit.

12. The multifunctional portable data sharing management device of claim 11, wherein the port unit is a card reader and a universal serial bus (USB).

13. The multifunctional portable data sharing management device of claim 1, further comprising a power supply unit coupled to the communication unit, the local storage unit and the processing unit for supplying a required power to the communication unit, the local storage unit and the processing unit, and selectively outputting the power to the outside of the multifunctional portable data sharing management device.

14. A multifunctional portable data sharing management device, provided for sharing data between a cloud server and a plurality of electronic devices, and the device comprising:
a communication unit, coupled to the electronic devices and the cloud server through the Internet;
a local storage unit, coupled to the communication unit, for selectively storing the data of the electronic devices; and
a processing unit, coupled to the communication unit and the local storage unit, for accessing the data stored in the cloud server, and transmitting the data to the electronic devices through the Internet, such that the electronic devices jointly use the data.

15. The multifunctional portable data sharing management device of claim 14, further comprising a media code unit having a data code stored therein, and coupled to at least one of the processing unit and the local storage unit, and provided for performing a coding and decoding data conversion of the data by the data code.

16. The multifunctional portable data sharing management device of claim 15, wherein the electronic devices download the data code from the media code unit through the communication unit and use the data code to perform the data conversion of the data in the electronic devices.

17. The multifunctional portable data sharing management device of claim 15, wherein the processing unit performs a data conversion of the data situated in the local storage unit, and transmits and broadcasts the data to the electronic devices.

18. The multifunctional portable data sharing management device of claim 16, wherein the processing unit transmits and broadcasts the data to the electronic devices by a data stream method.

19. The multifunctional portable data sharing management device of claim 17, wherein the processing unit transmits and broadcasts the data to the electronic devices by a data stream method.
